(19) United States
(12) Patent Application Publication
(10) Pub. No.: US 2025/0347340 A1
(43) Pub. Date: Nov. 13, 2025

(54) INERT GAS ENABLED EXTREME WEAR RESISTANCE OF ELECTRIFIED MOVING COMPONENTS

(71) Applicant: The Texas A&M University System, College Station, TX (US)

(72) Inventors: Ali Erdemir, College Station, TX (US); Leonardo Israel Farfan Cabrera, Puebla (MX); Seungjoo Lee, College Station, TX (US); Sean Skowron, Lake City, FL (US)

(21) Appl. No.: 19/265,643

(22) Filed: Jul. 10, 2025

Related U.S. Application Data
(63) Continuation of application No. PCT/US2024/011347, filed on Jan. 12, 2024.
(60) Provisional application No. 63/479,815, filed on Jan. 13, 2023.

(51) Int. Cl. F16H 57/04; F16H 57/02; F16H 57/027; F16H 57/029

(52) U.S. Cl. CPC F16H 57/0476; F16H 57/027; F16H 57/029; F16H 57/0471; F16H 2057/02034; F16H 2057/02043

(57) ABSTRACT

Hermetic sealing or encapsulation of critical components in an electromechanical system, rubbing surfaces, and the like allows for an extreme reduction in wear of moving components. For example, most of the transmission or gears of conventional or electric vehicles operate in a box or housing as in gear boxes. Adaptations may be made directly to these boxes so as to allow for inert gas-enabled reduction of wear on moving, electrified components contained within the boxes. Such boxes can be purged of air and then back-filled with dry nitrogen and/or other inert gases to prevent oxidation or oxidative/abrasive wear of rubbing substances. The concept can be adopted in stationary machinery as well, and the size of the inert gas tank can be made bigger in said stationary systems.

### CROSS REFERENCE TO RELATED APPLICATIONS

This is a continuation patent application which claims priority to PCT Serial No. PCT/US2024/011347, filed Jan. 12, 2024. The PCT application is hereby incorporated by reference in its entirety, including without limitation, the specification, claims, and abstract, as well as any figures, tables, appendices, or drawings thereof.

This application claims priority under to provisional patent application U.S. Ser. No. 63/479,815, filed Jan. 13, 2023. The provisional patent application is herein incorporated by reference in its entirety, including without limitation: the specification, claims, and abstract, as well as any figures, tables, appendices, or drawings thereof.

### TECHNICAL FIELD

The present invention relates generally to reducing wear of electrified moving components. More particularly, but not exclusively, the present invention enables wear resistance by encapsulating electrified moving components, such as the drivetrain of an electric vehicle, with inert gases, such as nitrogen.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Currently, surface oxidation related wear problems suppressed by adding anti-oxidant and anti-wear additives in lubricating oils. These additives are unfortunately environmentally harmful and hence are not desired. For example, the anti-wear additive (ZDDP) is especially harmful in that it has been known to poison aftertreatment catalysts in car engines.

Thus, there exists a need in the art for eliminating wear of moving components, including those that are subject to electric current discharges.

### SUMMARY

The following objects, features, advantages, aspects, and/or embodiments, are not exhaustive and do not limit the overall disclosure. No single embodiment needs to provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to positively impact the reliability of moving parts having electric currents that pass through a contact interface and trigger severe oxidation. Examples of moving parts include electric motors, generators, and the like. These components can include but are not limited to those components found in: industrial fans, blowers and pumps, machine tools, household appliances, power tools, wind turbines, vehicles, unmanned aerial vehicles (UAVs), drones, and disk drives. Small motors may be found even in electric watches, phones, and the like. In certain applications, such as in regenerative braking with traction motors, the components of the electric motors can be used in reverse as generators to recover energy that might otherwise be lost as heat and friction.

It is still yet a further object, feature, and/or advantage of the present disclosure to effectively dissipate and/or prevent electric current discharges caused by moving parts, including but not limited to: electric motors, generators, electromechanical machinery, etc.

It is still yet a further object, feature, and/or advantage of the present disclosure to hermetically seal a chamber containing the moving part with an inert gas. Hermetic sealing or encapsulation can be of the entire electromechanical system, or just critical components in an electromechanical system, or even of just the rubbing surfaces or section of the components within the electromechanical system.

It is still yet a further object, feature, and/or advantage of the present disclosure to enable ultra-high wear resistance to moving mechanical systems by allowing known lubricants, including both base oils and formulated oils, to function better. Lubricants can include, but are not limited to: base oils, formulated oils, other oils (e.g., water-based lubricants, ionic liquid-based lubricants, nano-colloidal lubricants, and coated surface engineered test samples). In some embodiments, this may eliminate the need to ever replace an initial amount of lubricant provided with a product at the point of sale. Specific lubricants evaluated in this disclosure include (i) PAO2; (ii) PAO10; (iii) Synthetic ATF; (iv) Dexron ATF; and (v) gear oil. PAO2 and PAO10 are polyalphaolefin-type lubricants. Polyalphaolefin is by far the most common major synthetic base oil used in industrial and automotive lubricants. It is a synthetic hydrocarbon (SHC) that mimics the best hydrocarbon (branched) structure found in mineral oils. Synthetic ATF and Dexron (sold by General Motors of Detroit, MI) ATF are automatic transmission fluids (ATF), which are a type of hydraulic fluid used in vehicles with automatic transmissions. ATFs are typically colored red or green to distinguish it from motor oil and other fluids in the vehicle. Gear oil is a lubricant made specifically for transmissions, transfer cases, wind turbine gear boxes, and differentials in automobiles, trucks, and other machinery. Gear oil is of a high viscosity and usually contains organosulfur compounds. Some modern automatic transaxles (integrated transmission and differential) do not use a heavy oil at all but lubricate with the lower viscosity hydraulic fluid, which is available at pressure within the automatic transmission. Most lubricants for manual gearboxes and differentials contain extreme pressure (EP) additives and anti-wear additives to cope with the sliding action of hypoid bevel gears. Typical additives for gear oil include dithiocarbonate derivatives and sulfur-treated organic compounds (“sulfurized hydrocarbons”).

It is still yet a further object, feature, and/or advantage of the present disclosure to provide a much greener solution than technology known in the art allows for when reducing the wear of moving components in mechanical, electromechanical, and electrical systems. And, if the solutions provided herein are adopted in the aggregate, this will help mitigate environmental issues, such as those associated with the need for frequent part repair, replacement, and/or disposal, which consumes energy and produces environmental pollution.

It is still yet a further object, feature, and/or advantage of the present disclosure to be able to utilize and reduce wear to components within the existing electromechanical system without needing to replace said components altogether and/or having to substantially customize the electromechanical system with new mechanical and/or electromechanical parts.

It is still yet a further object, feature, and/or advantage of the present disclosure to reduce wear on the sliding surfaces of bearing steels, preferably without altering or adversely affecting the friction coefficient. In some instances, the reduction of this wear can be as much as 90%, based on the experimental wear volume measurements with and without the use of inert gas, such as nitrogen in the test chamber. The data shows that when such an inert gas is used, the oxidation of rubbing substances is virtually eliminated. While when a non-inert gas is used, the wear is severe and the rubbing surfaces are highly oxidized and thus suffer oxidative wear. The oxide based debris particles generated during sliding are triggering severe abrasive wear, but when inert gas is used, the level of oxidation is essentially nil and the surfaces are not subject to severe abrasive wear due to oxide-based wear particles. The situation for electrified contact conditions are even worse; specifically, the rate of oxidation is very high for cases where tests are run in open air with oxygen; but, when the inert gas (nitrogen) environment is established, even under the conditions of electric current passing through the contact interface, the amount of wear is much lower.

It is still yet a further object, feature, and/or advantage of the present disclosure to positively impact the reliability of moving parts having electric currents running therethrough. For example, tests and measurements can be taken to study the exact effects of this positive impact: the studies contained herein show that even with the formulated gear and transmission oils in the drivetrain of an electric vehicle, significant benefits are still obtained from the use of inert gases. The wear volume is reduced more than 50% in some instances; hence, the use of inert gas-enabled reduction of wear is not limited to base oils but also works with formulated oil. This can help drastically reduce harmful additives or remove them completely from some applications, especially those that involve coatings (such as diamondlike carbon) where such additives were shown to have an adverse effect on coating durability and performance.

It is still yet a further object, feature, and/or advantage of the present disclosure to provide mechanical, electromechanical, and electrical systems that operate with higher precision that traditional systems while still benefitting from the increased longevity discussed herein.

It is still yet a further object, feature, and/or advantage to employ and/or understand the effects of a wide variety of inert gases, including but not limited to use of noble gases. For example, purified argon gas is the most commonly used inert gas due to its high natural abundance (78.3% N₂, 1% Ar in air) and low relative cost.

The use of inert gases to reduce the wear of electrified moving components disclosed herein can be used in a wide variety of applications. For example, the drivetrain of an electric vehicle can be encapsulated in a hermetically sealed chamber filled with an inert gas such as nitrogen. The present disclosure however is not limited to the powertrain components of electric vehicles because the data disclosed herein shows generally that even without the electricity passing through the contact interface, an inert gas environment can, in some instances, still reduce wear substantially. It is also worth mentioning other industrial applications that include electrified moving components, such as power generation turbines, electrical drives, unmanned aerial vehicles, drones, wind turbines, lunar and Martian vehicles, and the like, also stand to benefit from the use of inert gases to reduce wear. Yet another such example of electromechanical machinery with large, moving mechanical components is a spinning tube, commonly called spiral CT, or helical CT machine commonly used for conduct a computed tomography scan (CT) scan. CT scans utilize an imaging technique in which an entire X-ray tube is spun around the central axis of the area being scanned. These are the dominant type of scanners on the market because they have been manufactured longer and offer a lower cost of production and purchase. The main limitation of this type of CT is the bulk and inertia of the equipment (X-ray tube assembly and detector array on the opposite side of the circle) which limits the speed at which the equipment can spin. For example, the X-ray tube in a Siemens CT scanner is the most important and most expensive part in the system. Depending on usage, tubes and/or carbon brushes included in a CT scan machine will need to be replaced every few years. These components are housed in a gantry designed to hold radiation detectors and/or a radiation source. Therefore, the encapsulation of the tubes and/or carbon brushes in an inert gas chamber may help to sustain the quality of these components for the entire usable life of the CT-scan machine.

It is preferred the apparatus be safe, cost effective, and durable. For example, value is added to mechanical, electromechanical, and electrical systems which require less maintenance due to the increased longevity of electrified moving components contained therein. Moreover, electrified, moving components and other components in their immediate vicinity can be further adapted to resist excessive heat, static buildup, arcing, corrosion, and/or mechanical failures (e.g. cracking, crumbling, shearing, creeping) to complement any prolonged exposure to adverse conditions that the inert-gas-enabled increased longevity of the electrified moving component now allows for.

Methods can be practiced which facilitate use, manufacture, assembly, maintenance, and repair of electrified moving components which accomplish some or all of the previously stated objectives.

Electrified moving components can be hermetically sealed within a chamber filled with inert gas and later incorporated into larger mechanical, electromechanical, and electrical systems which accomplish some or all of the previously stated objectives.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 renders a perspective view of an electric motor and a transmission compartment, according to some aspects of the present disclosure.

FIG. 2 renders a perspective view of drivelines in which an electric motor is coupled to a transmission in the same cage or compartment, both being lubricated with the same lubricant, according to some aspects of the present disclosure.

FIG. 3 renders a perspective view of drivelines in which an electric motor and transmission are coupled in independent compartments, each compartment is lubricated in a different way, according to some aspects of the present disclosure.

FIG. 4 renders a perspective view of drivelines in which no gear transmission is used, i.e., a single electric motor, according to some aspects of the present disclosure.

FIG. 5 renders a perspective view of drivelines in which an electric motor is coupled to a transmission in the same cage or compartment, both being lubricated with the same lubricant, according to some aspects of the present disclosure.

FIG. 6 illustrates a schematic view of a test system for evaluating the efficacy of inert gases in preventing wear of electrified moving components, according to some aspects of the present disclosure.

FIG. 7 captures a photograph using the exemplary test setup shown and described in FIG. 6, according to some aspects of the present disclosure.

FIG. 8 charts and compares disk wear (a wear loss volume comparison) in (i) dry (unlubricated: two hundred meters [200 m] sliding distance), unelectrified conditions (OA) and (ii) dry (unlubricated: two hundred meters [200 m] sliding distance), electrified (3A) conditions for (a) air, (b) nitrogen, (c) carbon dioxide, and (d) argon, according to some aspects of the present disclosure.

FIG. 9 graphs friction coefficients (y-axis, unitless) as a function of time (in seconds) under dry (unlubricated: two hundred meters [200 m] sliding distance) conditions, according to some aspects of the present disclosure. Experimental results are provided with respect to both the unelectrified and electrified conditions of FIG. 8 for each of (a) air, (b) nitrogen (N₂), (c) carbon dioxide (CO₂), and (d) argon (Ar). Inert gases show a dramatic effect in reducing wear.

FIG. 10 charts and compares disk wear (a wear loss volume comparison) in (1) lubricated, unelectrified (OA) conditions; and (2) lubricated, electrified (3A) conditions, for each of the following lubricants (i) PAO2; (ii) PAO10; (iii) Synthetic ATF (labeled in the Figure as ATF); (iv) Dexron ATF (labeled in the Figure as Dexron); and (v) gear oil, and for both (a) air and (b) nitrogen, according to some aspects of the present disclosure.

FIG. 11 shows the results of the graph of FIG. 10 on a logarithmic scale, according to some aspects of the present disclosure.

FIG. 12 charts and compares disk wear (a wear loss volume comparison) for a disk lubricated with PAO2 in (i) unelectrified conditions (OA) and (ii) electrified (3A) conditions for (a) air, (b) nitrogen, (c) carbon dioxide, and (d) argon, according to some aspects of the present disclosure.

FIG. 13 graphs friction coefficients as a function of time (in seconds) with respect to the use of PAO2 for each of the conditions described above and with reference to FIG. 12, according to some aspects of the present disclosure. FIG. 13 also shows images taken by a scanning electron microscope (SEM) of the sample Dexron ATF during each of the aforementioned conditions: the images resulting from scanning the surface of the sample gear oil with a focused beam of electrons.

FIG. 14 charts and compares disk wear (a wear loss volume comparison) for a disk lubricated with Dexron ATF, at different DC currents, including: (i) 0 amps (GA); (ii) one amp (1A); and (iii) three amps (3A), for both (a) air and (b) nitrogen, according to some aspects of the present disclosure.

FIG. 15 charts and compares disk wear (a wear loss volume comparison) for a disk lubricated with Dexron ATF in (i) unelectrified conditions (OA) and (ii) electrified (3A) conditions for (a) air, (b) nitrogen, (c) carbon dioxide, and (d) argon, according to some aspects of the present disclosure.

FIG. 16 graphs friction coefficients as a function of time (in seconds) with respect to the use of Dexron ATF for each of the conditions described above and with reference to FIG. 15, according to some aspects of the present disclosure. FIG. 16 also shows images taken by a scanning electron microscope (SEM) of the sample Dexron ATF during each of the aforementioned conditions: the images resulting from scanning the surface of the sample gear oil with a focused beam of electrons.

FIG. 17 charts and compares wear loss volume of a boride coating in (i) unelectrified conditions and (ii) electrified conditions for both (a) air and (b) nitrogen, according to some aspects of the present disclosure.

FIG. 18 charts and compares wear loss volume of gear oil at different loads, including: (i) five newtons (5N) and (ii) ten newtons (ION), for both (a) air and (b) dry nitrogen (N₂), according to some aspects of the present disclosure.

FIG. 19 graphs friction coefficients as a function of time (in seconds) with respect to the use of the gear oil for each of the conditions described above and with reference to FIG. 18, according to some aspects of the present disclosure. FIG. 19 also shows images taken by a scanning electron microscope (SEM) of the sample gear oil during each of the aforementioned conditions: the images resulting from scanning the surface of the sample gear oil with a focused beam of electrons.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

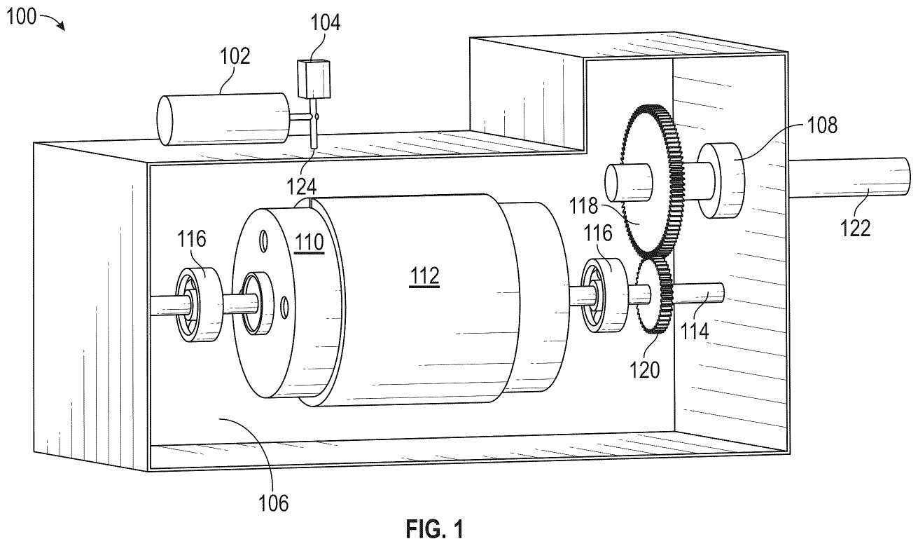

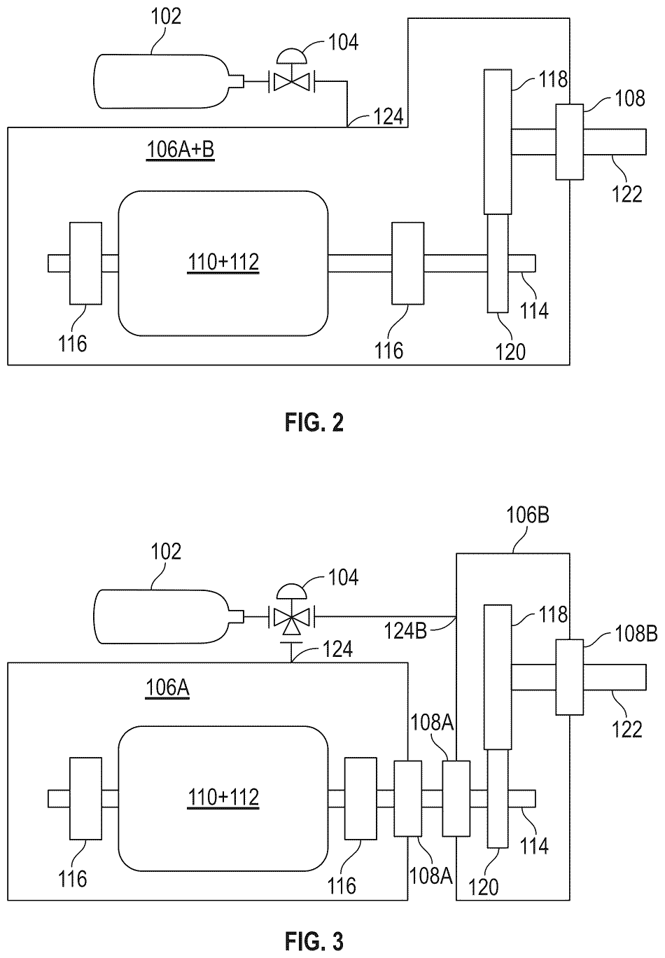

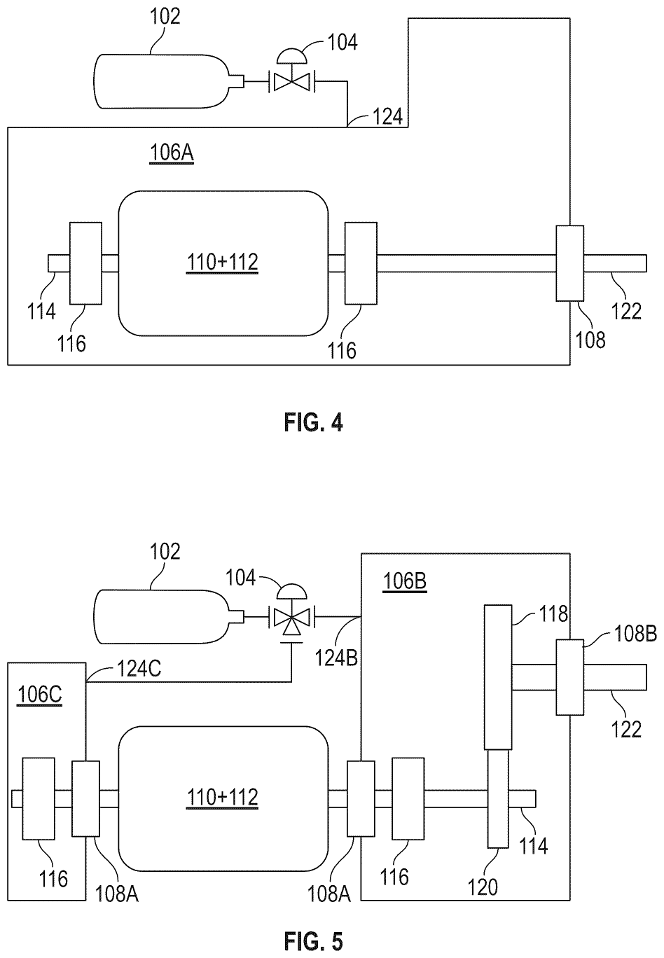

Referring now to the Figures, FIGS. 1-5 show an inert-gas enabled reduction of wear system 100. The inert-gas enabled reduction of wear system 100 in this particular embodiment is at least a portion of an electric drivetrain (hereinafter drivetrain 100) with an electric motor and transmission, though it is to be understood that similar configurations of an inert-gas chamber could benefit electric motors, large electromechanical machinery, etc.

The drivetrain 100 is improved by way of a fluidic connection to an inert gas tank 102 and a pressure controller 104, which allow for an inert gas to pass into the chamber 106 or a compartment 106A, 106B, 106C thereof. In some embodiments, the pressure controller can also allow for the inert gas to pass out of the chamber 106 or a compartment 106A, 106B, 106C thereof.

The inert gas tank 102 can be any receptacle or enclosure for holding a product used to store the inert gas and can comprise any material strong enough to hold same, such as steel.

The pressure controller 104 allows for mechanical ventilation of a fluid. The pressure controller 104 can be used to regulate pressures applied during mechanical ventilation, and in some embodiments can provide the added ability to regulate temperature. It is to be appreciated that the pressure controller 104 can regulate inert gas delivered into a chamber 106 by either measuring a total volume of the inert gas in the chamber 106 and/or a pressure, e.g., a total pressure exerted on the housing of the chamber 106.

The housing of the chamber 106 can be sized large enough to house all components of the mechanical system 100. The housing of the chamber 106 can include a single chamber, as is shown in FIGS. 1 & 4; bifurcated into two compartments 106A, 106B, as is shown in FIG. 3; include a main chamber with a minor compartment 106C located completely therewithin; and/or can be dedicated to housing just a subset of components within the system 100, e.g., the dedicated chambers 106B, 106C as shown in FIG. 5.

In preferred embodiments, the chamber(s) 106 and compartment(s) 106A-C are hermetically sealed with hermetic seals 108. The hermetic seals 108 can comprise an electric motor compartment seal such as an oil seal 108A, a transmission compartment seal such as a gas seal 108B, or other seal/lubricants that do not allow air to pass between components that pass through the boundaries of the chamber 106 to deliver power to and from other mechanical components of the drivetrain 100, such as those that operate the wheels of a vehicle.

The drivetrain 100 delivers mechanical power from the prime mover to driven components. The drivetrain includes rotor 110, a stator 112, a motor shaft 114, bearings 116, a first gear 118, e.g., a driveshaft gear, a second gear 120, e.g., motor shaft gear, and driveshaft 122. As the driveshaft 122 rotates, a first gear 118 rotates and therefore rotates a second gear 120, which in turn rotates the motor shaft 114 and rotor 110.

The components in the electric motor compartment 106A convert electrical energy into mechanical energy. For example, the electric motor can operate through the interaction between the motor's magnetic field and electric current in a wire winding to generate force in the form of torque applied on the motor's shaft 114. An electric generator is mechanically identical to an electric motor, but operates with a reversed flow of power, converting mechanical energy into electrical energy. It should be appreciated the use of an inert gas to reduce wear on components of an electric motor could likewise be applied to an electric generator.

The electric motor can be powered by direct current (DC) sources, such as from batteries, or rectifiers, or by alternating current (AC) sources, such as a power grid, inverters or electrical generators, be brushed or brushless, single-phase, two-phase, or three-phase, axial or radial flux, and may be air-cooled or liquid-cooled. Electric motors may be classified by considerations such as power source type, construction, application and type of motion output. Electric motors produce linear or rotary force (torque) intended to propel some external mechanism, such as a fan or an elevator. An electric motor is generally designed for continuous rotation, or for linear movement over a significant distance compared to its size. Magnetic solenoids are also transducers that convert electrical power to mechanical motion, but can produce motion over only a limited distance.

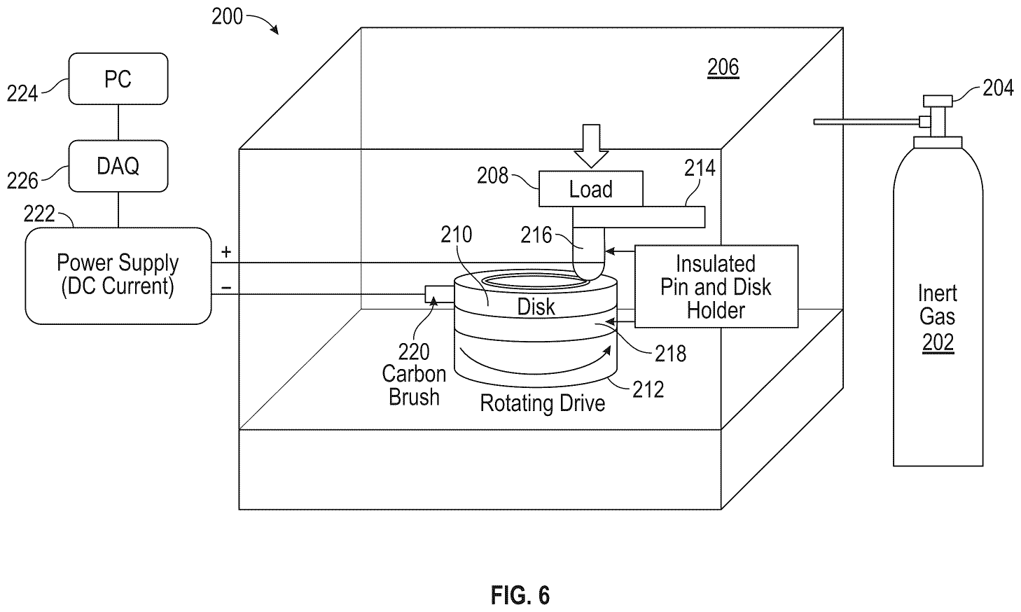

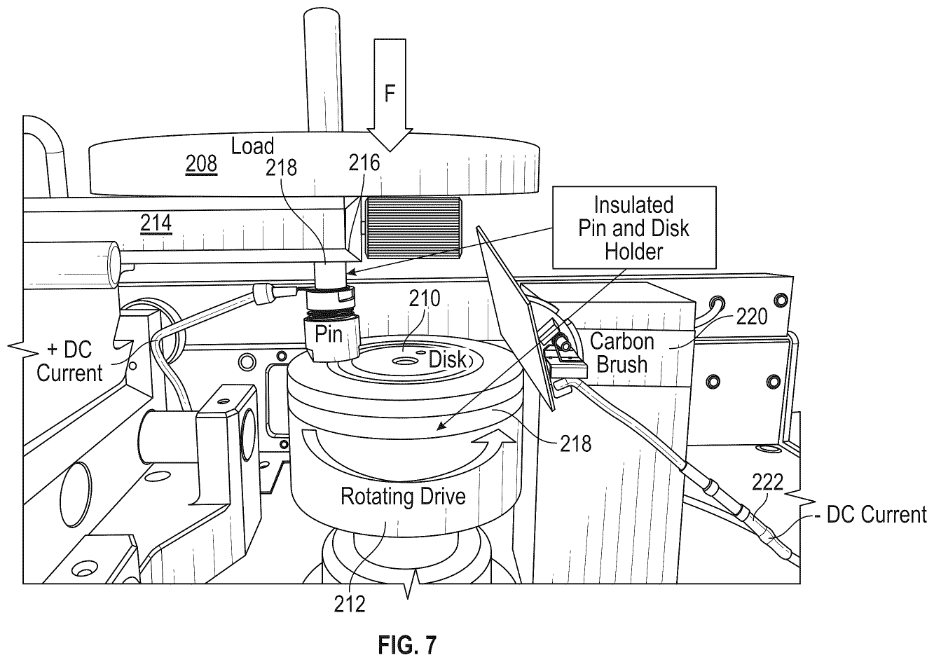

Examples of a DC power source and wires carrying the DC power are shown in FIGS. 6-7.

The chamber 106 comprises a controlled fluidic inlet and/or outlet 124 that allows inert gas to pass therethrough. More than one fluidic inlet and/or outlet 124A, 124B, 124C can be used where inert gas is delivered to more than one chamber 106 and/or compartment 106A, 106B, 106C. It is to be appreciated that each of the fluidic inlet/outlet(s) 124 can be divided into a separate fluidic inlet and a separate, fluidic outlet so that flow of inert gas is only one-direction at each fluidic entry/exit point into the chamber 106 and/or compartment 106A, 106B, 106C. Valves can help control (both direction and intensity) flow of an inert gas through the fluidic inlet and/or outlet 124 and in some embodiments, can even be controlled by the pressure controller 104.

### Examples

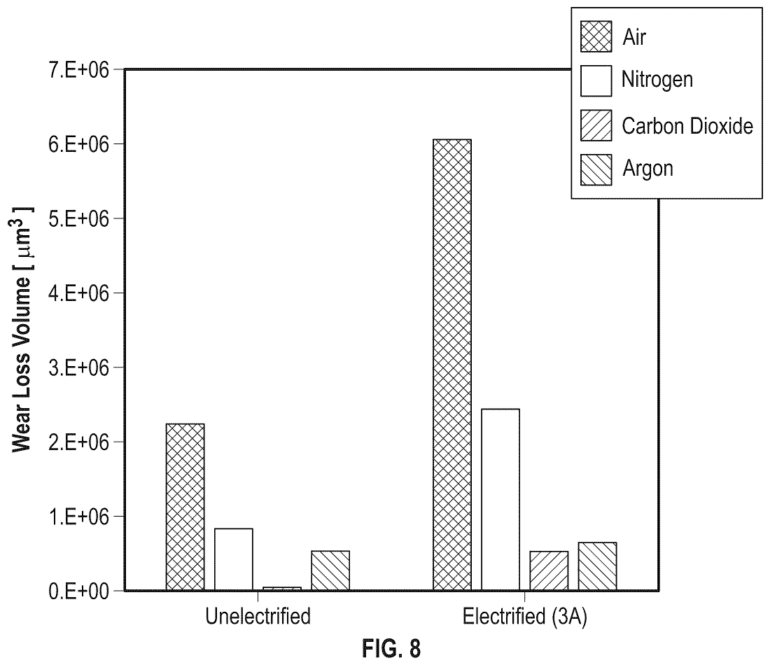

FIGS. 6-7 illustrate a test system 200 for evaluating the efficacy of inert gases on preventing wear of electrified moving components, according to some aspects of the present disclosure, and FIGS. 8-19 chart results of the use of same.

The test system 200 comprises an inert gas tank 202, a pressure controller 204, and a chamber 206, which are meant to represent the inert gas tank 102, pressure controller 104, and chamber(s) 106, described above with reference to FIGS. 1-5. The description of the inert gas tank 102, pressure controller 104, and chamber(s) 106 are herein incorporated by reference with respect to the inert gas tank 202, pressure controller 204, and chamber 206 for purposes of understanding function of same.

To conduct a test, a load 208 is applied to a disk 210, which is attached to a rotating drive 212. The load 208 can be placed onto a support plate 214 and does not need to be directly applied to the disk 210. This can help improve the longevity of the test system 200. An insulated pin 216 can be the component that applies said load 208. Like the support place, a disk holder 218 can help support the disk 210.

A carbon brush 220 is an electrical contact which conducts current between stationary wires and moving parts, i.e., between the disk 210 and rotating drive 212. This can emulate the conduction of current between the rotor 110 and stator 112, or even between the rotating motorshaft 114/driveshaft 122 and other stationary components. The lifespan of a carbon brush can depend on how much the electric motor is used, and how much power is put through the motor. Thus, the carbon brush in this specific test system 200 may need to be replaced after repeated use.

A DC power supply 222 is shown in FIG. 6 and wires carrying DC power are shown in FIG. 7. There are wires shown that carry both positive DC current 222+ and negative DC current 222−.

The amount of power in the carbon brush 220 can be monitored and/or displayed by a personal computer (PC) 224 utilizing data acquisition 226. Data acquisition 226 samples the signals that measure real-world physical conditions (e.g. power through the carbon brush 220) and converts the resulting samples into digital numeric values that can be manipulated by the personal computer 224. The data acquisition 226 typically converts analog waveforms into digital values for processing. The components of a data acquisition system can include, but is not limited to including: sensors, to convert physical parameters to electrical signals; signal conditioning circuitry, to convert sensor signals into a form that can be converted to digital values; and analog-to-digital converters, to convert conditioned sensor signals to digital values.

Data acquisition 226 is usually controlled by software programs developed using various general purpose programming languages such as Assembly, BASIC, C, C++, C#, Fortran, Java, LabVIEW, Lisp, Pascal, etc. These programs can be executed by the personal computer 224.

After using the test system 200, the results of FIGS. 8-19 were obtained by data acquisition 226 and displayed on the personal computer 224. In particular, the following breakthroughs were observed.

FIG. 8 charts and compares disk wear in (i) dry, unelectrified conditions and (ii) dry, electrified conditions for (a) air, (b) nitrogen, (c) carbon dioxide, and (d) argon. Dry conditions for this example are characterized by unlubricated sliding conditions, with a sliding distance of two hundred meters (200 m). The results shown in FIG. 8 quantify wear loss volume in cubic micrometers (3).

For a chamber filled with air, an increase from a wear loss volume that is slightly more than 2×10⁶ μm³ under unelectrified conditions (OA) to a wear loss volume slightly that is slightly more than 6×10⁶ μm³ under electrified conditions (3A) was observed. For a chamber filled with nitrogen (N₂), an increase from a wear loss volume that is slightly less than 1×10⁶ μm³ under unelectrified conditions (OA) to a wear loss volume slightly that is slightly more than 2×10⁶ μm³ under electrified conditions (3A) was observed. For a chamber filled with carbon dioxide (CO₂), an increase from a wear loss volume that is slightly more than 0×10⁶ μm³ under unelectrified conditions (OA) to a wear loss volume slightly that is approximately one half of 1×10⁶ μm³ under electrified conditions (3A) was observed. For a chamber filled with Argon (Ar), only a very negligible increase a wear loss volume slightly that is approximately one half of 1×10⁶ μm³ was observed.

The results evidence that air causes a higher wear volume in both unelectrified mechanical components and electrified mechanical components than the use of nitrogen (N₂), carbon dioxide (CO₂), and argon (Ar). A substantially greater impact on wear resistance is observed for the comparison amongst air and nitrogen/carbon dioxide/argon for the electrified components than the unelectrified components, though even unelectrified components could stand to benefit from the storage of same in containers that are filled with an inert gas.

Surprisingly, the increase in disk wear from unelectrified conditions to electrified conditions with respect to the use of argon (Ar) appears to be extremely negligible. This suggests that the more inert the gas is, the greater the benefit in the reduction of wear when transitioning from unelectrified to electrified conditions, as is common for electric components in electrically powered vehicles.

Additionally, a surprising result is achieved in that carbon dioxide (CO₂), the creation of which through combustion processes is usually thought to a detriment, can now be recycled for a very positive purpose (to eliminate wear on components which are electrified and/or experiences changes in electrification/non-electrification).

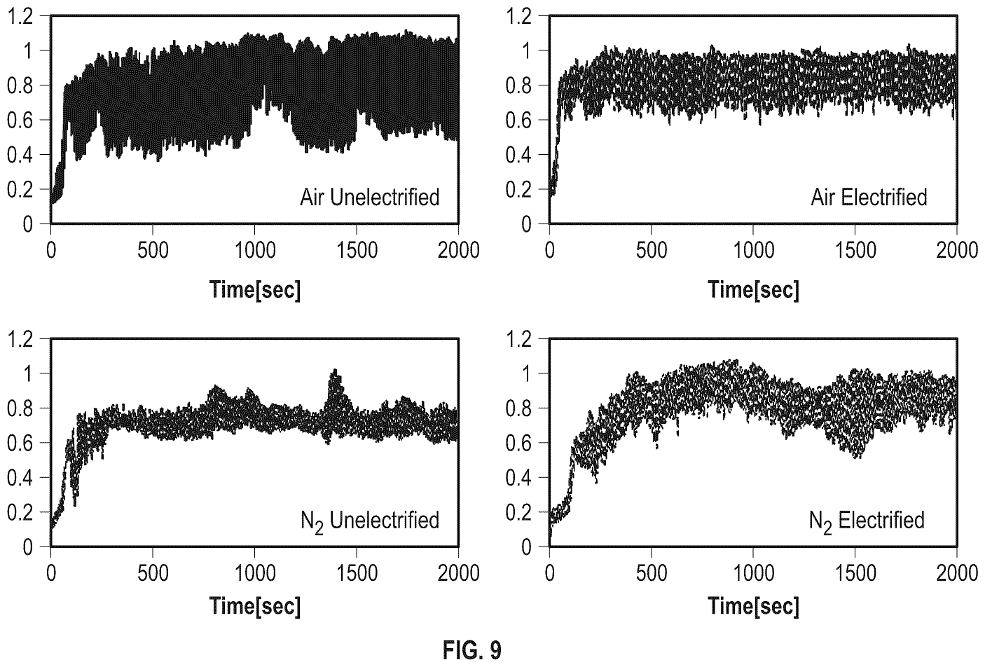

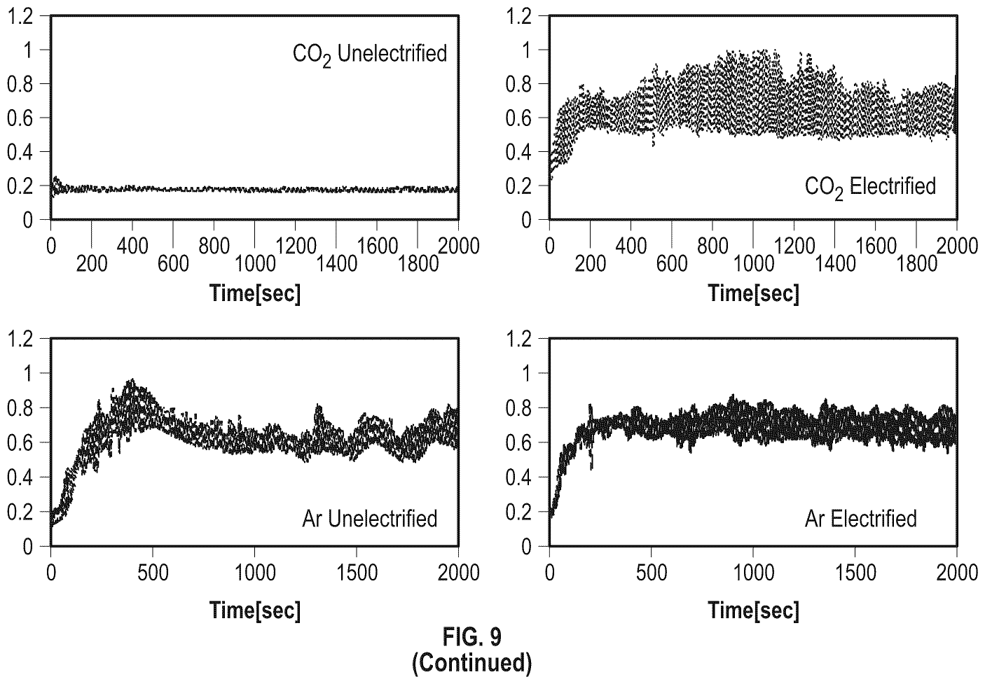

FIG. 9 graphs friction coefficients as a function of time in seconds. Friction coefficients were graphed for at least two thousand seconds (2000 s). The same dry conditions of FIG. 8 are used (unlubricated: two hundred meters [200 m] sliding distance). Experimental results are provided with respect to both the unelectrified and electrified conditions for each of (a) air, (b) nitrogen (N₂), (c) carbon dioxide (CO₂), and (d) argon (Ar). Inert gases show a dramatic effect in reducing wear.

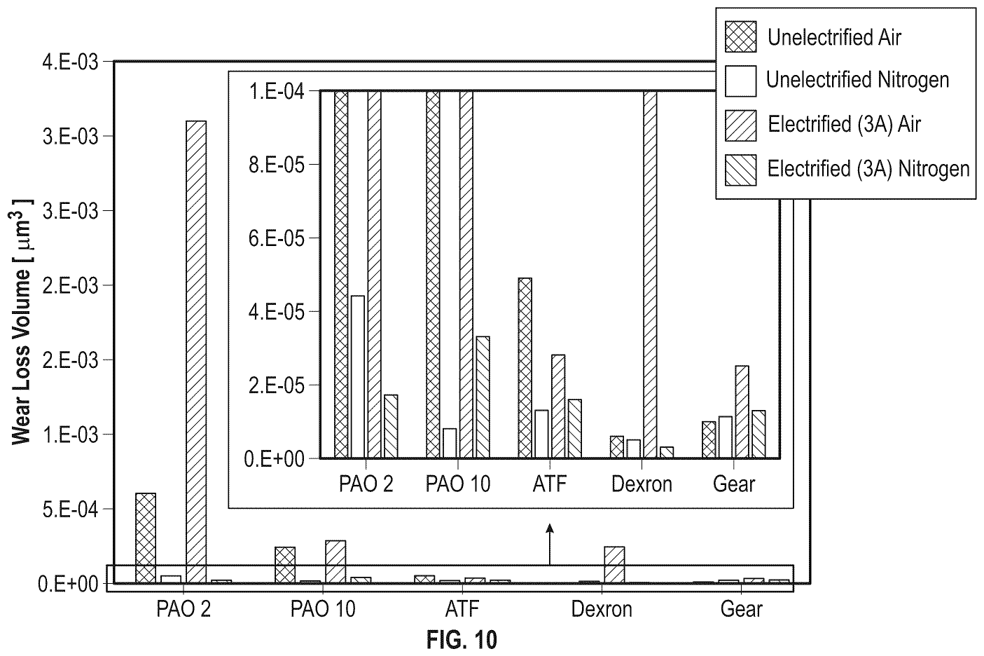

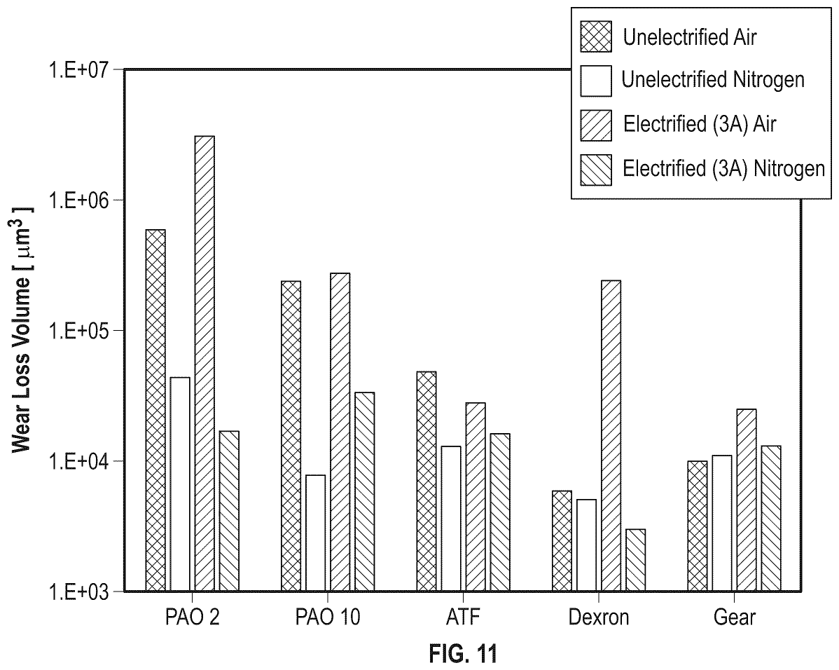

FIGS. 10-11 charts and compares disk wear in (1) lubricated, unelectrified conditions and (2) lubricated, electrified conditions for (i) PAO2; (ii) PAO10; (iii) Synthetic ATF; (iv) Dexron ATF; and (v) gear oil for both (a) air and (b) nitrogen. FIG. 10 is presented on a normal scale in cubic millimeters (mm³) and includes a detailed view of the very bottom sliver of the scale, while FIG. 11 is presented in cubic micrometers (μm³) on a logarithmic scale.

For a chamber filled with air and a disk lubricated by PAO2, an increase from a wear loss volume that is slightly more than 5×10⁻⁴ mm³ under unelectrified conditions (OA) to a wear loss volume slightly that is slightly more than 3×10⁻³ mm³ under electrified conditions (3A) was observed. For a chamber filled with nitrogen (N₂) and a disk lubricated by PAO2, a very surprising decrease from a wear loss volume that is slightly more than 4×10⁻⁵ mm³ under unelectrified conditions (OA) to a wear loss volume slightly that is slightly less than 2×10⁻⁵ mm³ under electrified conditions (3A) was observed. For a chamber filled with air and a disk lubricated by PAO10, only a very negligible increase a wear loss volume slightly that is approximately one half of 5×10−4 mm³ was observed when transitioning from unelectrified (OA) to electrified (3A) conditions. For a chamber filled with nitrogen (N₂) and a disk lubricated by PAO10, an increase from a wear loss volume that is approximately 1×10⁻⁵ mm³ under unelectrified conditions (OA) to a wear loss volume slightly that is approximately 3×10⁻⁵ mm³ under electrified conditions (3A) was observed. For a chamber filled with air and a disk lubricated by Synthetic ATF, a very surprising decrease from a wear loss volume that is slightly more than 4×10⁻⁵ mm³ under unelectrified conditions (OA) to a wear loss volume slightly that is approximately 3×10⁻⁵ mm³ under electrified conditions (3A) was observed. For a chamber filled with nitrogen (N₂) and a disk lubricated by Synthetic ATF, only a very negligible increase a wear loss volume slightly that is approximately 2×10⁻⁵ mm³ was observed when transitioning from unelectrified (OA) to electrified (3A) conditions. For a chamber filled with air and a disk lubricated by Dexron ATF, a very substantial increase from a wear loss volume that is slightly less than 1×10⁻¹ mm³ under unelectrified conditions (OA) to a wear loss volume slightly that is slightly more than 2×10−4 mm³ under electrified conditions (3A) was observed. For a chamber filled with nitrogen (N₂) and a disk lubricated by Dexron ATF, a very surprising decrease from a wear loss volume that is slightly less than 1×10⁻⁵ mm³ under unelectrified conditions (OA) to a wear loss volume slightly that is approximately half of 1×10⁻¹ mm³ under electrified conditions (3A) was observed. For a chamber filled with air and a disk lubricated by gear oil, an increase from a wear loss volume that is slightly less than 1×10⁻¹ mm³ under unelectrified conditions (0A) to a wear loss volume slightly that is slightly more than 2×10⁻⁵ mm³ under electrified conditions (3A) was observed. For a chamber filled with nitrogen (N₂) and a disk lubricated by gear oil, an increase from a wear loss volume that is slightly less than 1×10⁻¹ mm³ under unelectrified conditions (0A) to a wear loss volume slightly that is slightly more than 1×10⁻⁵ mm³ under electrified conditions (3A) was observed.

The results shown in FIGS. 10-11 evidence the use of air causes a higher wear volume in both unelectrified mechanical components and electrified mechanical components than the use of nitrogen for each and every lubricant/oil tested. Interestingly, the results further evidence that for the lubricant Dexron ATF, and to a lesser extent, synthetic ATF, the wear volume may actually decrease over time after the component is electrified. This may mean that for components lubricated with Dexron ATF, and to a lesser extent, synthetic ATF, it may make sense to store some components in an electrified state rather than in an unelectrified state (the standard procedure) if the main goal is to reduce overall and the cost of keeping the component in an electrified state is not greater than the potential benefit. Therefore, it makes sense to conduct further testing of Dexron ATF to evaluate at what powers this unique observation ceases to be true.

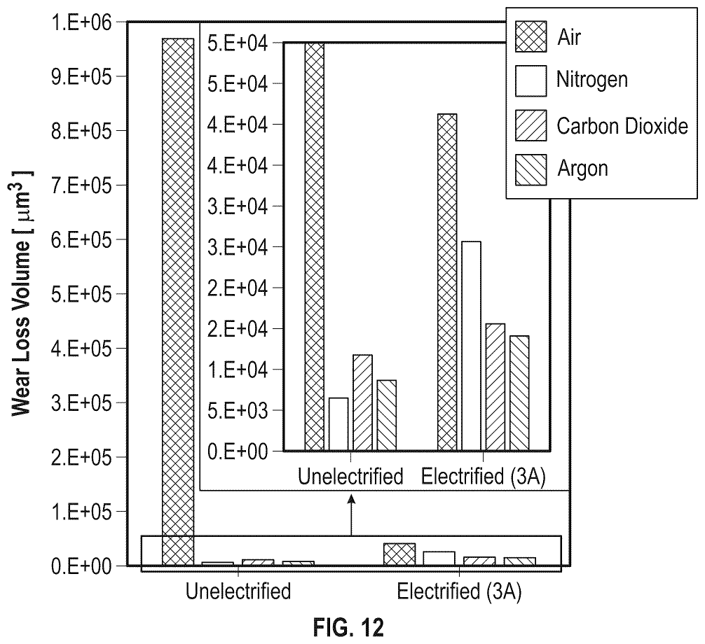

FIG. 12 charts and compares disk wear for a disk lubricated with PAO2 in (i) unelectrified conditions and (ii) electrified conditions for (a) air, (b) nitrogen, (c) carbon dioxide, and (d) argon. The results shown in FIG. 12 quantify wear loss volume in cubic micrometers (μm³).

For a chamber filled with air, a surprising decrease from a wear loss volume that is slightly less than 1×10⁶ μm³ under unelectrified conditions (0A) to a wear loss volume slightly that is slightly more than 4×10⁴ μm³ under electrified conditions (3A) was observed. For a chamber filled with nitrogen (N₂), an increase from a wear loss volume that is slightly less than 5×10³ μm³ under unelectrified conditions (GA) to a wear loss volume slightly that is slightly less than 1×10⁴ μm³ under electrified conditions (3A) was observed. For a chamber filled with carbon dioxide (CO₂), a very slight increase from a wear loss volume that is slightly more than 1×10⁴ μm³ under unelectrified conditions (0A) to a wear loss volume slightly less than 2×10⁴ μm³ under electrified conditions (3A) was observed. For a chamber filled with Argon (Ar), a very slight increase from a wear loss volume that is slightly less than 1×10⁴ μm³ under unelectrified conditions (0A) to a wear loss volume slightly less than 2×10⁴ μm³ under electrified conditions (3A) was observed.

The results evidence that air causes a higher wear volume in both unelectrified mechanical components and electrified mechanical components than the use of nitrogen (N₂), carbon dioxide (CO₂), and argon (Ar), even when the lubricant PAO2 is applied to the disk. A substantially greater impact on wear resistance is observed for the comparison amongst air and nitrogen/carbon dioxide/argon for the electrified components than the unelectrified components, though even unelectrified components could stand to benefit from the storage of same in containers that are filled with an inert gas.

Surprisingly, the increase in disk wear from unelectrified conditions to electrified conditions with respect to the use of carbon dioxide (CO₂) appears to be extremely negligible when the lubricant PAO2 is applied to the disk. This suggests that compound gases may experience a greater synergistic effect on reducing wear when combined with a lubricant than would be expected.

Additionally, a surprising result is achieved in that carbon dioxide (CO₂), the creation of which through combustion processes is usually thought to a detriment, can now be recycled for a very positive purpose (to eliminate wear on components which are electrified and/or experiences changes in electrification/non-electrification).

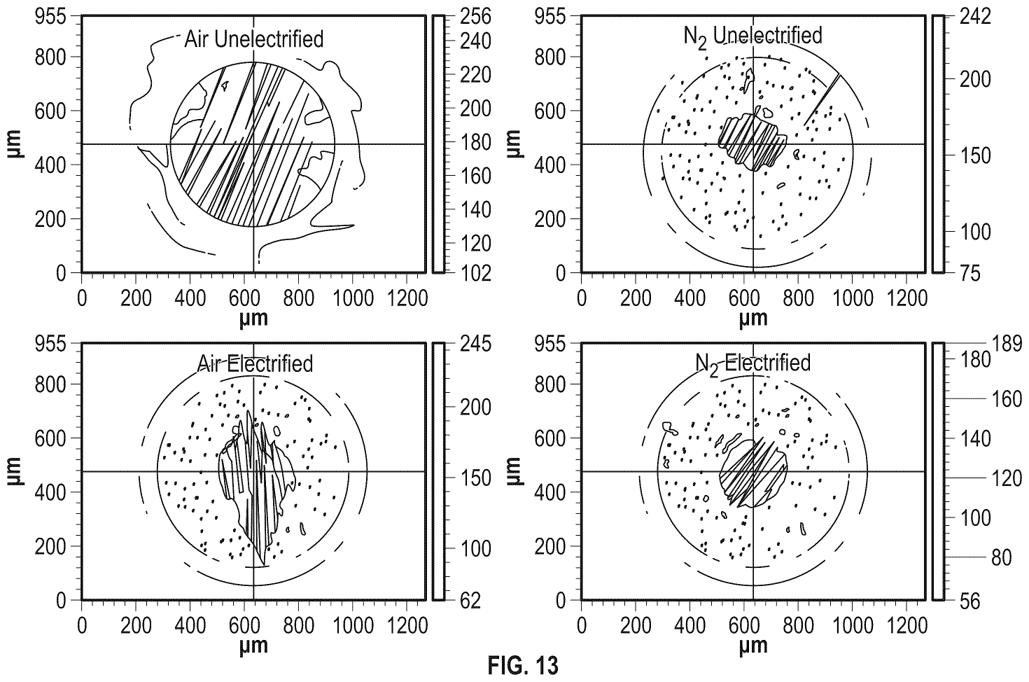

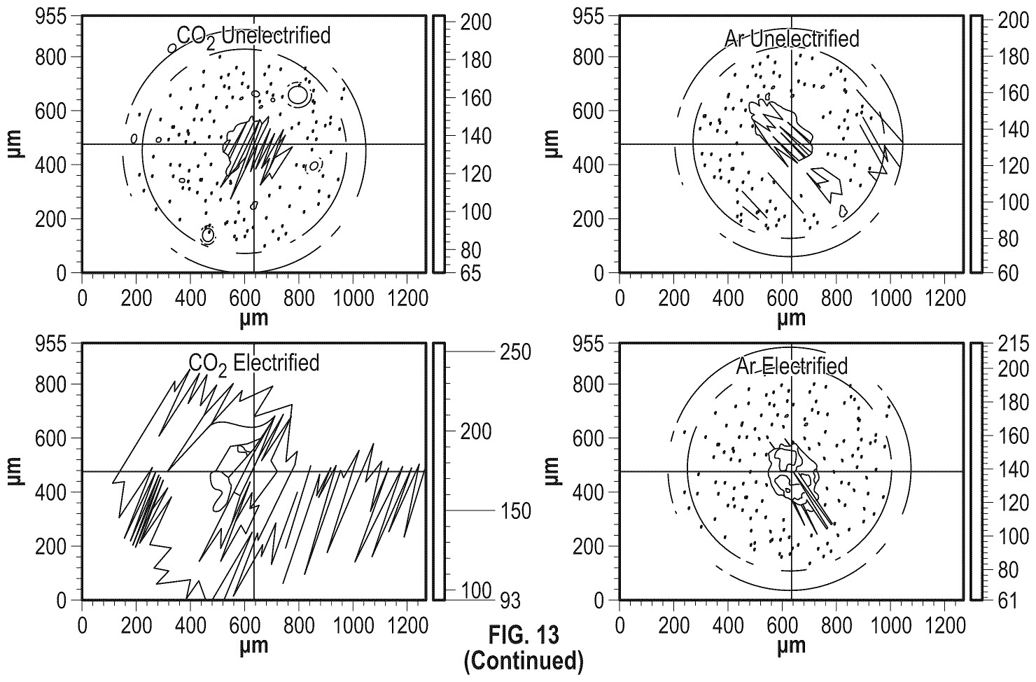

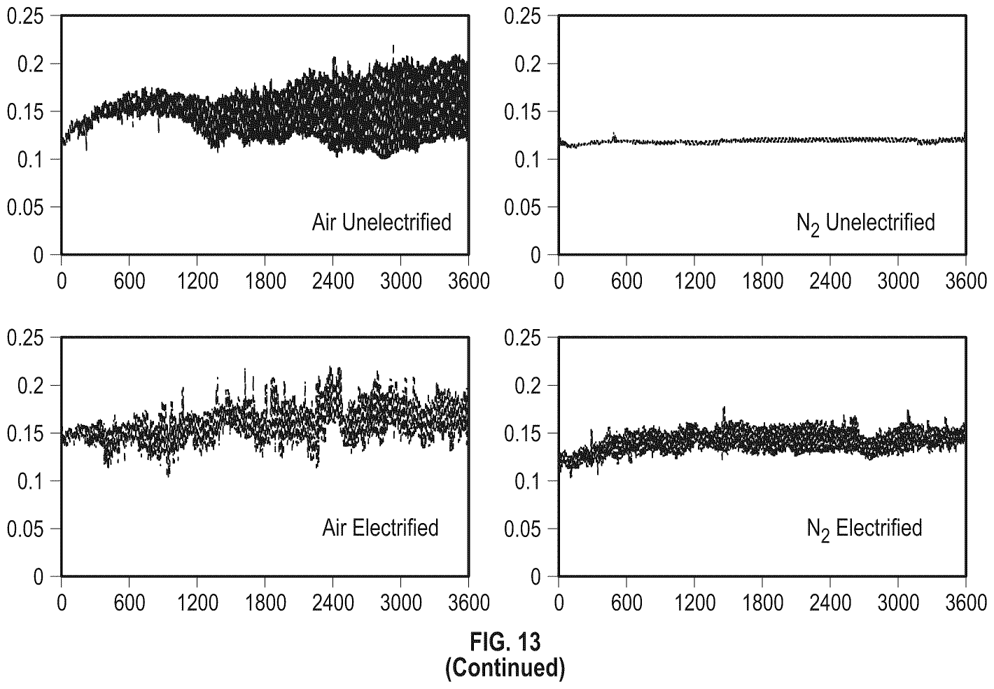

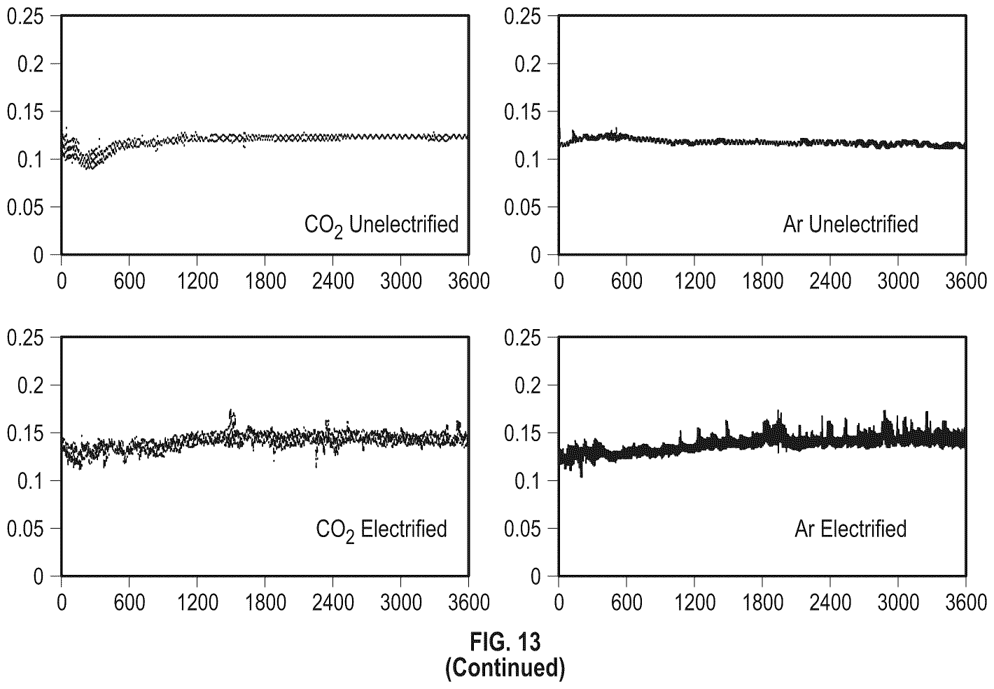

FIG. 13 shows images taken by a scanning electron microscope (SEM) of the sample PAO2 during each of same lubricated conditions of FIG. 12 (using PAO2 in electrified and unelectrified conditions). The images result from scanning the surface of the sample PAO2 with a focused beam of electrons.

FIG. 13 also graphs friction coefficients as a function of time in seconds. Friction coefficients were graphed for at least two thousand seconds (2000 s). Experimental results are provided with respect to both the unelectrified and electrified conditions for each of (a) air, (b) nitrogen (N), (c) carbon dioxide (CO₂), and (d) argon (Ar). Inert gases show a dramatic effect in reducing wear.

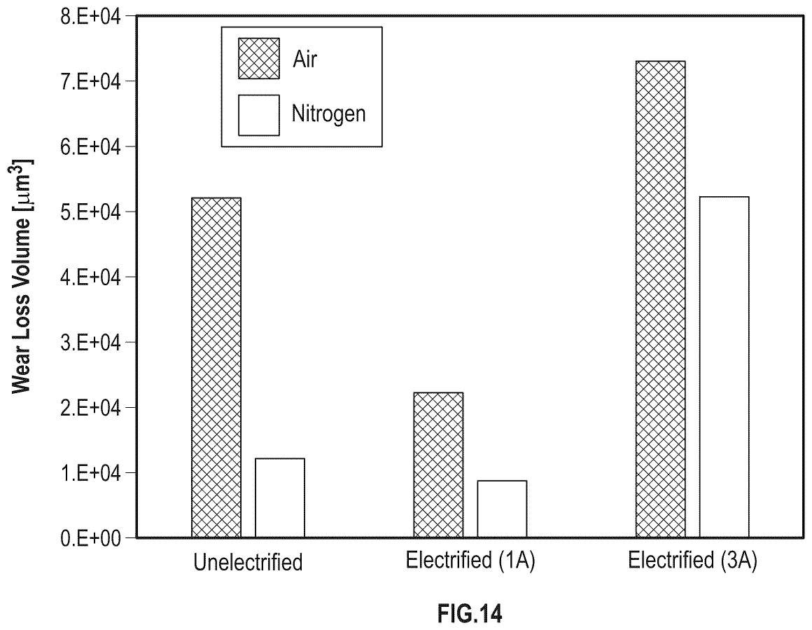

FIG. 14 charts and compares wear loss volume of a disk lubricated with Dexron ATF at different DC currents, including: (i) 0 amps (0A); (ii) one amp (1A); and (iii) three amps (3A), for both (a) air and (b) nitrogen. The results shown in FIG. 14 evidence that the application of one amp of energy may actually help reduce wear in components lubricated with Dexron ATF regardless of whether the components are stored in chambers with air and/or nitrogen.

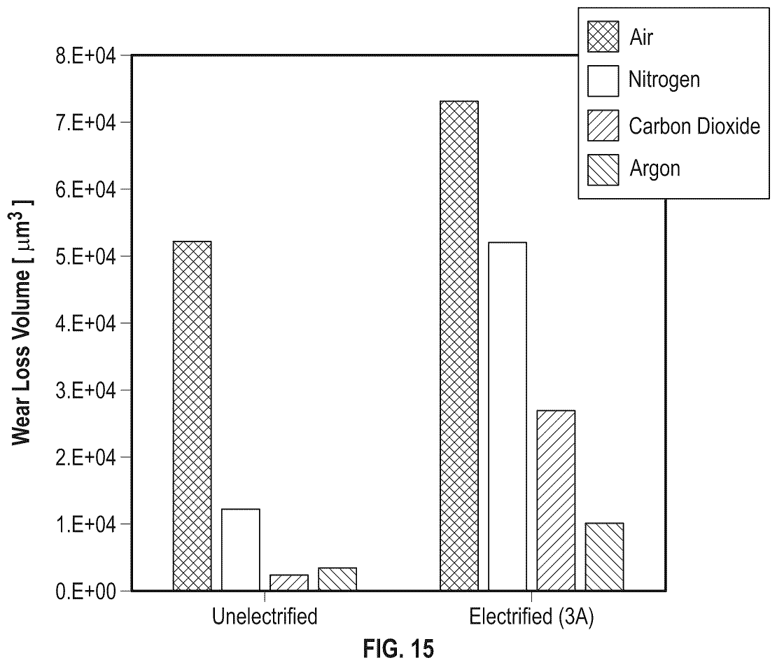

FIG. 15 charts and compares disk wear for a disk lubricated with Dexron ATF in (i) unelectrified conditions and (ii) electrified conditions for (a) air, (b) nitrogen, (c) carbon dioxide, and (d) argon. The results shown in FIG. 15 quantify wear loss volume in cubic micrometers (μm³).

For a chamber filled with air, an increase from a wear loss volume that is slightly more than 5×10⁴ μm³ under unelectrified conditions (0A) to a wear loss volume slightly that is slightly more than 7×10⁴ μm³ under electrified conditions (3A) was observed. For a chamber filled with nitrogen (N₂), an increase from a wear loss volume that is slightly more than 1×10⁴ μm³ under unelectrified conditions (0A) to a wear loss volume slightly that is slightly more than 5×10⁴ μm³ under electrified conditions (3A) was observed. For a chamber filled with carbon dioxide (CO₂), a very slight increase from a wear loss volume that is slightly more than 0×10⁴ μm³ under unelectrified conditions (0A) to a wear loss volume slightly more than 2×10⁴ μm³ under electrified conditions (3A) was observed. For a chamber filled with Argon (Ar), a very slight increase from a wear loss volume that is slightly more than 0×10⁴ μm³ under unelectrified conditions (0A) to a wear loss volume slightly less than 1×10⁴ μm³ under electrified conditions (3A) was observed.

The results evidence that air causes a higher wear volume in both unelectrified mechanical components and electrified mechanical components than the use of nitrogen (N₂), carbon dioxide (CO₂), and argon (Ar), even when the lubricant Dexron ATF is applied to the disk. A substantially greater impact on wear resistance is observed for the comparison amongst air and nitrogen/carbon dioxide/argon for the electrified components than the unelectrified components, though even unelectrified components could stand to benefit from the storage of same in containers that are filled with an inert gas.

Surprisingly, the increase in disk wear from unelectrified conditions to electrified conditions with respect to the use of argon (Ar) appears to be extremely negligible when the lubricant Dexron ATF is applied to the disk. This suggests that the more inert the gas is, the greater the benefit in the reduction of wear when transitioning from unelectrified to electrified conditions, as is common for electric components in electrically powered vehicles.

Additionally, a surprising result is achieved in that carbon dioxide (CO₂), the creation of which through combustion processes is usually thought to a detriment, can now be recycled for a very positive purpose (to eliminate wear on components which are electrified and/or experiences changes in electrification/non-electrification).

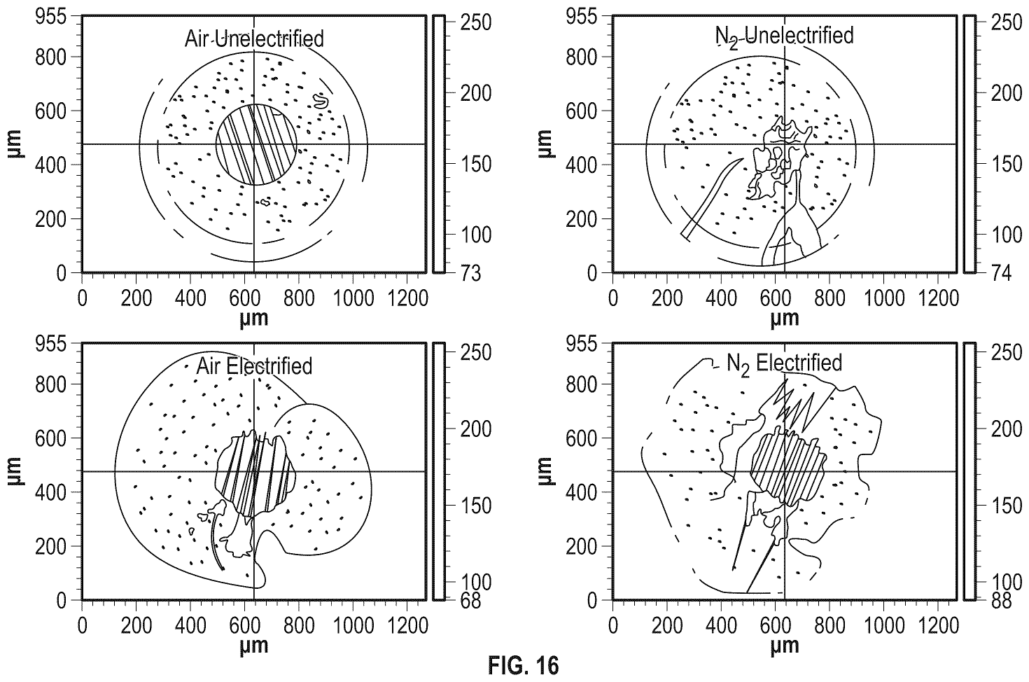

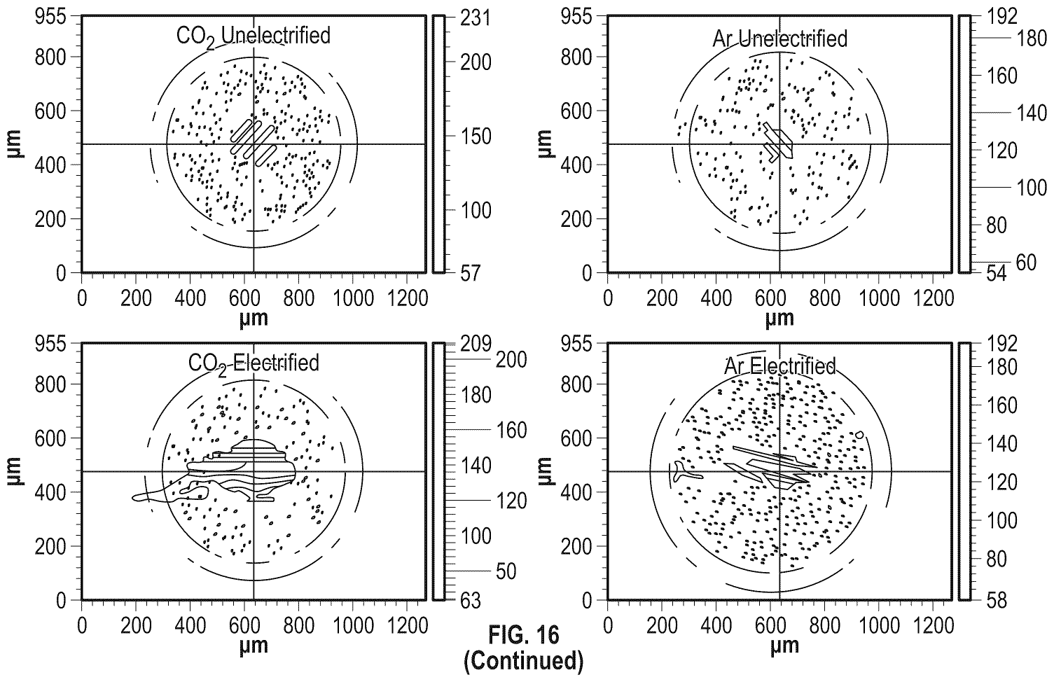

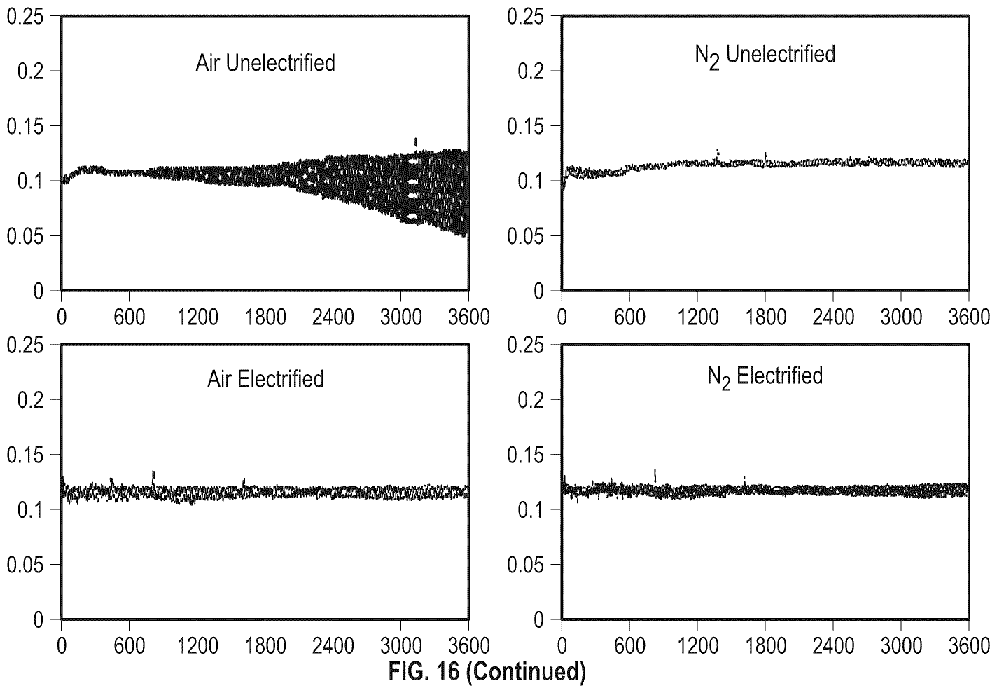

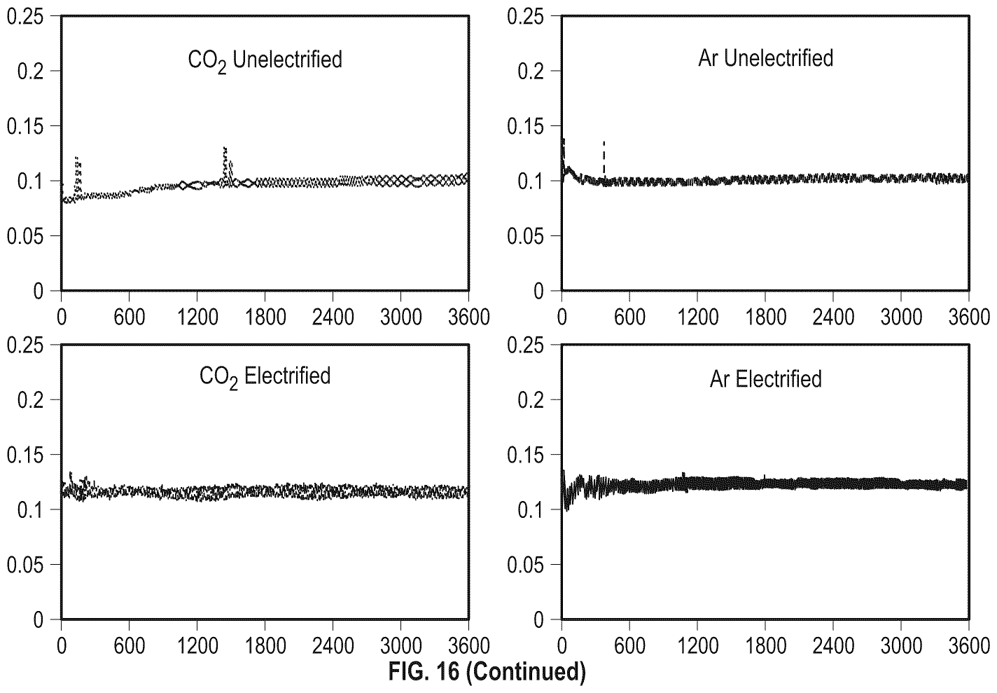

FIG. 16 shows images taken by a scanning electron microscope (SEM) of the sample Dexron ATF during each of same lubricated conditions of FIG. 15 (using Dexron ATF in electrified and unelectrified conditions). The images result from scanning the surface of the sample Dexron ATF with a focused beam of electrons.

FIG. 16 also graphs friction coefficients as a function of time in seconds. Friction coefficients were graphed for at least two thousand seconds (2000 s). Experimental results are provided with respect to both the unelectrified and electrified conditions for each of (a) air, (b) nitrogen (N₂), (c) carbon dioxide (CO₂), and (d) argon (Ar). Inert gases show a dramatic effect in reducing wear.

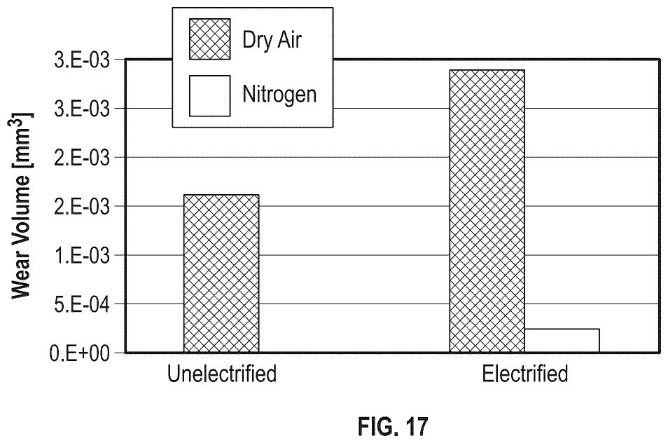

FIG. 17 charts and compares wear loss volume of a boride coating in (i) unelectrified conditions and (ii) electrified conditions for both (a) air and (b) nitrogen.

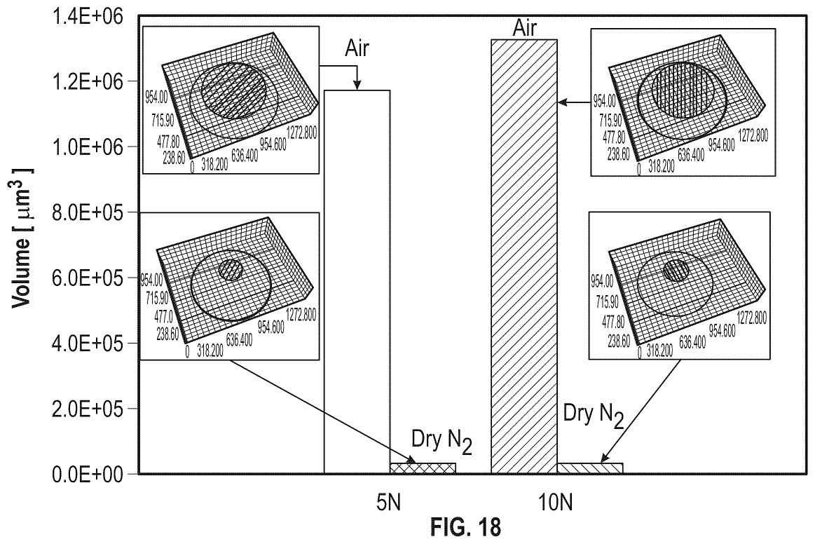

FIG. 18 charts and compares wear loss volume of gear oil at different loads, including: (i) five newtons (5N) and (ii) ten newtons (ION), for both (a) air and (b) nitrogen (N₂).

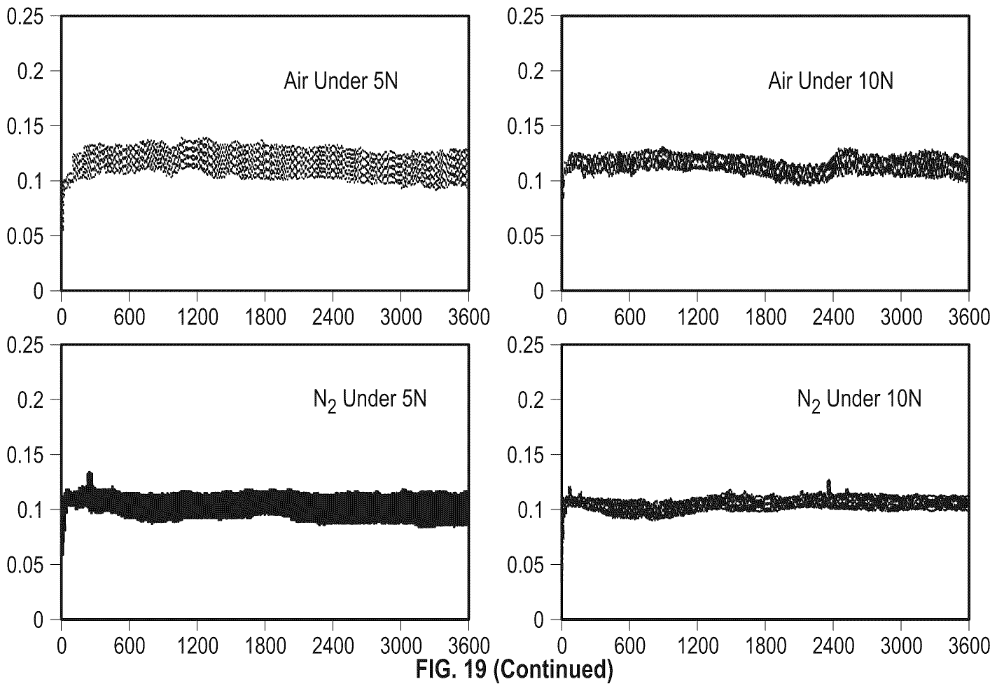

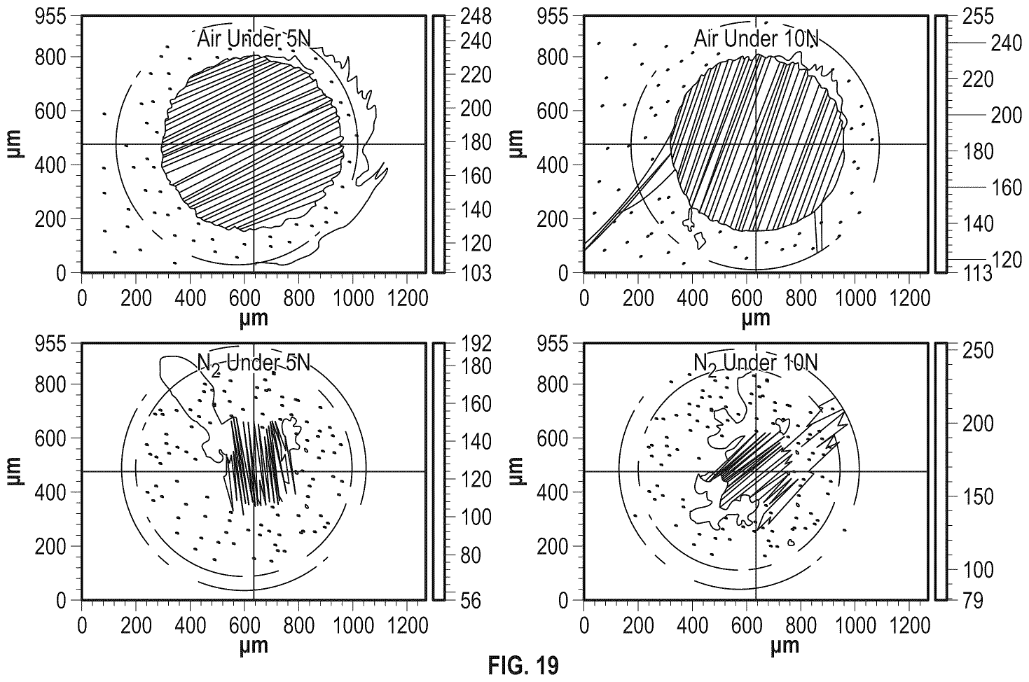

FIG. 19 graphs friction coefficients as a function of time in seconds. Friction coefficients were graphed for at least two thousand seconds (2000 s). Experimental results are provided with respect to both the unelectrified and electrified conditions for each of (a) air, (b) nitrogen (N₂), (c) carbon dioxide (CO₂), and (d) argon (Ar). Inert gases show a dramatic effect in reducing wear.

FIG. 19 also shows images taken by a scanning electron microscope (SEM) of the sample gear oil during each of same lubricated conditions of FIG. 18 (using gear oil in electrified and unelectrified conditions). The images result from scanning the surface of the sample gear oil with a focused beam of electrons.

The results shown in FIGS. 17-19 evidence the use of air causes a higher wear volume than the use of nitrogen for the boride coating after electrification and for the gear oil as it was placed under a higher load.

It is to be understood by one of ordinary skill in the art will understand that in some appropriate instances where a gas is only generically referred to, that the qualifying phrase “dry” could also apply. As an example, where Applicant refers to just “nitrogen” or just “carbon dioxide”, Applicant is also expressly in possession of “dry nitrogen” and “dry carbon dioxide” being used in those circumstance(s).

From the foregoing, it can be seen that the present disclosure accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 100 | inert-gas enabled reduction of wear system, e.g., a drivetrain of an |
| | electric vehicle adapted with an inert gas tank |
| 102 | inert gas tank |
| 104 | pressure controller |
| 106 | chamber |
| 106A | electric motor compartment |
| 106B | transmission compartment |
| 106C | bearing compartment |
| 108 | hermetic seal |
| 108A | electric motor compartment seal, e.g., oil seal |
| 108B | transmission compartment seal, e.g., gas seal |
| 110 | rotor |
| 112 | stator |
| 114 | motor shaft |
| 116 | bearings |
| 118 | first gear, e.g., driveshaft gear |
| 120 | second gear, e.g., motor shaft gear |
| 122 | driveshaft |
| 124 | fluidic inlet/outlet into chamber housing |
| 124A | fluidic inlet/outlet into electric motor compartment |
| 124B | fluidic inlet/outlet into transmission compartment |
| 124C | fluidic inlet/outlet into bearing compartment |
| 200 | test system |
| 202 | inert gas tank |
| 204 | pressure controller |
| 206 | chamber |
| 208 | load |
| 210 | disk |
| 212 | rotating drive |
| 214 | support plate |
| 216 | insulated pin |
| 218 | disk holder |
| 220 | carbon brush |
| 222 | power supply |
| 222+ | positive DC current |
| 222− | negative DC current |
| 224 | personal computer (PC) |
| 226 | data acquisition (DAQ) |

### Glossary

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

A “drivetrain” is the group of components that deliver mechanical power from the prime mover to the driven components. As used herein, “drivetrain” can refer to a subset of components that include the movable, electrified parts that make up the main drivers of the drivetrain, and does not necessarily refer to all components of a motor vehicle that deliver power to the drive wheels. The term “drivetrain” typically excludes the engine or motor that generates the power, however in this application it should be appreciated that any use of the term drivetrain can (but is not require to unless context indicates otherwise) include the engine or motor. Furthermore, the term drivetrain, as used herein, can be interchangeably used with the term “powertrain”, which is typically considered to include both the engine and/or motor(s) as well as the drivetrain, if the context allows.

An electric vehicle (EV) is a vehicle that uses one or more electric motors for propulsion. It can be powered by a collector system, with electricity from extravehicular sources, or it can be powered autonomously by a battery (sometimes charged by solar panels, or by converting fuel to electricity using fuel cells or a generator). EVs include but are not limited to road and rail vehicles, and broadly can also include electric boat and underwater vessels (submersibles, and technically also diesel- and turbo-electric submarines), electric aircraft and electric spacecraft. Electric road vehicles include electric passenger cars, electric buses, electric trucks and personal transporters such as electric buggy, electric tricycles, electric bicycles and electric motorcycles/scooters. Together with other emerging automotive technologies such as autonomous driving, connected vehicles and shared mobility, EVs form a future vision of transportation called Connected, Autonomous, Shared and Electric (CASE) mobility. EVs include hybrid electric vehicles, where electric motors are used as a supplementary propulsion to internal combustion engines.

An “inert gas” is a gas that does not readily undergo chemical reactions with other chemical substances and therefore does not readily form chemical compounds. The noble gases often do not react with many substances and have historically been referred to as the inert gases. Inert gases are used generally to avoid unwanted chemical reactions degrading a sample, such as oxidation reactions. The term inert gas is context-dependent. The term inert gas can include gases that are thought to be only “semi-inert”, or even traditionally reactive gases that that are non-reactive in the specific environment in which they are being employed. Conversely, even several of the noble gases can be made to react under certain conditions and may not be considered inert. Example gases other than the noble gases that can comprise include nitrogen (N₂). Unlike noble gases, an inert gas is not necessarily elemental and can be a compound gas, such as carbon dioxide (CO₂). Noble gases such as Argon (Ar) have the tendency for non-reactivity due to the valence, the outermost electron shell, being complete in Argon and each of the other noble gases. Noble gases and other “inert” gases can react to form compounds, which would mean that in context that they are not fully “inert”.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. A system (100) for reducing the wear on an electrified component comprising:
an enclosed chamber (106) filled with an inert gas; and
a mechanical component (110, 112, 116, 118, 120) that, during operation, is electrified.

2. The system (100) of claim 1, wherein the enclosed chamber (106) is hermetically sealed.

3. The system (100) of claim 1, further comprising a hermetic seal (108) fluidly positioned between the enclosed chamber (106) and the environment.

4. The system (100) of claim 3, wherein the hermetic seal (108) is a gas seal (108B) or an oil seal (108A).

5. The system (100) of claim 1, wherein the inert gas comprises argon (Ar), nitrogen (N₂), or carbon dioxide (CO₂).

6. The system (100) of claim 1, wherein during operation the movable component (110, 112, 116, 118, 120) is electrified with direct current (DC).

7. The system (100) of claim 1, wherein the mechanical component (110, 112, 116, 118, 120) comprises a movable component.

8. The system (100) of claim 1, wherein the movable component (110, 112, 116, 118, 120) comprises a rotor (110) attached to a stator (112).

9. The system (100) of claim 1, wherein the movable component (110, 112, 116, 118, 120) is operatively attached to a rotatable shaft (114, 122), wherein the rotatable shaft (114, 122) optionally comprises a driveshaft (122) or a motor shaft (114).

10. The system (100) of claim 1, wherein the movable component (110, 112, 116, 118, 120) is driven by at least one gear (118, 120) that comprises a first gear (118) directly attached to a driveshaft (122) and a second gear (120) directly attached to a motor shaft (114), wherein turning the first gear (118) causes the second gear (120) to turn, which in turn causes the movable component (110, 112, 116, 118, 120) to move.

11. The system (100) of claim 1, wherein the chamber (106) comprises a controlled fluidic inlet and/or outlet (124) that allows inert gas to pass therethrough, wherein the fluidic inlet and/or outlet (124) comprises a fluidic inlet and a separate fluidic outlet.

12. The system (100) of claim 1, wherein a flow of an inert gas through the fluidic inlet and/or outlet (124) is controlled by a fluid valve and/or a pressure controller (104).

13. A system (100) for reducing the wear on an electrified component comprising:
an enclosed chamber (106) fluidly connected to an inert gas supply (102); and
a movable component (110, 112, 116, 118, 120) that, during operation, is electrified.

14. The system (100) of claim 13, wherein the system (100) is a drivetrain of an electric vehicle.

15. The system (100) of claim 13, wherein the enclosed chamber (106) comprises an electric motor compartment (106A), a transmission compartment (106B), or a bearing compartment (106C).

16. The system (100) of claim 15, wherein the electric motor compartment (106A) is fluidly connected to the inert gas supply (102), the transmission compartment (106B) is fluidly connected to the inert gas supply (102), or the bearing compartment (106C) is fluidly connected to the inert gas supply (102).

17. The system (100) of claim 13, wherein the enclosed chamber (106) is a gear box.

18. The system (100) of claim 13, further comprising a pressure controller (104) that regulates a pressure of an inert gas delivered to said enclosed chamber (106) from the inert gas supply (102).

19. A method of reducing wear in an electrifiable moving component comprising:
encapsulating the movable electrifiable moving component (110, 116, 118, 120) with an inert gas kept in close proximity to said electrifiable moving component (110, 116, 118, 120); and
controlling pressure of an enclosed chamber housing the electrifiable moving component (110, 116, 118, 120) with a pressure controller (104) operatively connected to the enclosed chamber (106);
wherein the inert gas is initially placed into at least one compartment of the enclosed chamber (106), said at least one compartment being completely and hermetically sealed during an entire usable life of the electrifiable moving component (110, 116, 118, 120).

20. The method of claim 19, further comprising:
electrifying the electrifiable moving component (110, 116, 118, 120); and
powering a machine or an automobile with the electrifiable moving component (110, 116, 118, 120).
